(19) United States
(12) Patent Application Publication
(10) Pub. No.: US 2025/0129985 A1
(43) Pub. Date: Apr. 24, 2025

(54) DRYER FOR DRYING BOARDS AT LOW TEMPERATURES

(71) Applicant: GRENZEBACH BSH GmbH, Bad Hersfeld (DE)

(72) Inventor: Christoph STRAETMANS, Wippershain (DE)

(73) Assignee: GRENZEBACH BSH GmbH, Bad Hersfeld (DE)

(21) Appl. No.: 18/689,950

(22) PCT Filed: Sep. 11, 2022
(86) PCT No.: PCT/EP2022/025424

§ 371 Date: Mar. 7, 2024

(30) Foreign Application Priority Data
Sep. 11, 2021 (DE) 10 2021 004 578.5

(51) Int. Cl. F26B 15/12; F26B 3/04; F26B 21/08; F26B 23/00

(52) U.S. Cl. CPC F26B 15/12; F26B 3/04; F26B 21/086; F26B 23/002

(57) ABSTRACT

A dryer for drying boards to be conveyed through the dryer in a plurality of sections extending one behind the other in the longitudinal direction and each having a plurality of levels using a heating medium at a temperature below 130° C., characterized in that the boards are heated during the drying process in a first zone in the longitudinal direction and in the conveying direction of the boards with warm air flowing between the levels, the boards can be heated to a temperature below 130° C. in a first zone in the longitudinal direction and in the conveying direction of the boards by warm air generated by a first heater in one or a first plurality of zones, and in that the air can be led out of the dryer counter to the conveying direction through at least one first heat exchanger after absorbing moisture from the boards.

The invention relates to a dryer for drying boards according to the preamble of claim 1.

Boards to be dried, for example gypsum plasterboards, gypsum fiberboards or other mineral-bonded boards or veneers, are conveyed through a dryer by means of a conveyor system.

Gypsum plasterboards essentially consist of a gypsum core, which is covered with cardboard on the surface and longitudinal sides. The gypsum core consists of gypsum and various additives that give the board technological properties, such as fire protection or moisture resistance.

In a gypsum calcining plant, gypsum is burned into stucco plaster. During this process, water of crystallization is removed by heating, which causes the gypsum to recrystallize into setting plaster. In a subsequent plant for the production of plasterboard, the plaster is mixed with various additives and water in a mixer. The liquid plaster slurry is then evenly applied to the base board. The edges of the lower board are folded over. The top board is then glued on from above. Next, a strand of gypsum plasterboard with the cardboard glued around it is applied to a long binding tape, on which it sets; the continuous strand is then cut to the desired length. The wet plasterboards are then turned over and conveyed to several levels in a dryer via a level feeder, where they are dried in a horizontal position on a number of levels, typically eight to fourteen levels. As soon as the plasterboards have reached the required residual moisture content, they are processed and stacked ready for dispatch.

The dryer consists, for example, of drying chambers, sections or sections of the same length, which are repeated in the dryer in a similar or identical manner in the direction in which the boards pass through. The dryer is a continuously operating continuous dryer, which the boards, in particular the plasterboards, leave as dried boards after passing through it.

DE 10 2009 059 822 B4 discloses a dryer for drying boards in which the boards are guided through the drying chambers in levels, the boards being brought into contact with drying air by means of impingement jet ventilation and the impingement jet ventilation being ensured by means of cross-ventilated nozzle boxes.

WO 2019/105888 A1 discloses a method for drying boards. in particular plasterboards, in which, for drying the boards moving through a dryer, a first drying medium is heated to a temperature above 140° C. via a first heating means and then the heated first drying medium is directed onto the boards in a hot drying zone;
wherein two or more heat recovery means are provided to recover heat from the exhaust gas drying medium of the hot drying zone and utilize the recovered heat to heat a second drying medium to a temperature below the temperature of the first drying medium without additional heating means. The heated second drying medium is directed to boards in a plurality of hot drying zones downstream of the hot drying zone, wherein the cooled exhaust drying medium is directed from upstream heat recovery means via downstream recovery means; and for each of the two or more heat recovery means, the recovered heat is directed to one or more hot drying zones associated with that heat recovery means.

In the low-temperature range, i.e. at temperatures of 150° C. or less, in particular at temperatures below 100° C., nozzle boxes for targeted impingement jet ventilation are not required because there is no risk of uneven drying here and the boards cannot therefore be damaged by uneven drying. For this reason, the use of nozzle boxes in a low-temperature dryer is not necessary; it is sufficient to ventilate the boards to be dried with warm air in the longitudinal and/or transverse direction.

The advantage of low-temperature drying is that it can preferably be combined with heat exchangers or other concepts for utilizing the warm air. Low-temperature drying is often implemented in conjunction with environmentally friendly or energy-saving measures. The reason for this is that the low temperatures mean that low-calorific heat sources can be used to generate energy. Examples of this are solar collectors or process exhaust air from other plant components, which are used very efficiently in this area.

It is the object of the invention to create a dryer by means of which boards can also be dried at low temperatures.

According to the invention, this object is solved as specified in patent claim 1.

During the drying process, the boards are heated in a first zone in the longitudinal direction and in the conveying direction of the boards to a temperature preferably below 130° C. in a section or in a first plurality of sections with warm air generated by a first heater flowing between the levels, and the air is led out of the dryer through at least one first heat exchanger in the opposite direction to the conveying direction after absorbing moisture from the boards.

The invention thus relates to a drying concept with a low-temperature dryer with drying temperatures of preferably below 100° C., in particular from 50 to 90° C., instead of the otherwise usual 200 to 300° C. However, the low-temperature dryer according to the invention can also be used at temperatures of up to 150° C. At such low temperatures, it is possible to use low-calorific heat sources, such as solar collectors or process exhaust air from other parts of the system. However, the drying time of the boards, in particular the gypsum plasterboards, is extended at lower drying temperatures. The dryer according to the invention is cross-ventilated. Flat boards, for example plasterboard, are dried horizontally in the low-temperature dryer.

Because the drying time of the boards to be dried, in particular the gypsum plasterboards, is several times longer, the invention creates a system for drying the gypsum plasterboards which, compared to the state of the art, allows a larger number of boards, in particular gypsum plasterboards, to be dried and transported per room unit. can be dried and transported per room unit by creating a lot of space for the boards to be dried per room unit of a floor of the dryer by means of a transport means that only takes up a small amount of space, in particular transport rollers with a small diameter, through which the boards are transported horizontally. Instead of drying a sheet material, the dryer according to the invention is also suitable for drying an endless strand of a material to be dried.

A drying system is created which is adapted to a dryer operating at low temperature and to the high number of boards, in particular plasterboard, which are processed in the low-temperature dryer simultaneously over a high number of levels, for example forty levels. Low-temperature dryers with up to sixty shelves arranged one above the other can also be realized according to the invention. In this case, the shelf height is between 90 and 150 mm, for example 100 mm. The boards to be dried have a thickness of 6 to 25 mm. The boards are conveyed via transport rollers which form a roller conveyor and of which, in a preferred embodiment, all or at least half are driven. In an alternative embodiment, the dryer is a belt dryer in which the sheets are conveyed via conveyor belts.

A dryer of this type consumes 30% less energy than a conventional high-temperature dryer, for example.

By using a large number of shelves in conjunction with the drive system according to the invention, a longer dwell time of the boards, in particular the plasterboards, can be realized in a low-temperature dryer with the same dryer length as in a high-temperature dryer.

Advantageous further embodiments of the invention are also apparent from the sub-claims and the description, in particular in conjunction with the drawings.

The invention provides a low-temperature dryer with indirect heating. In a preferred embodiment, this indirect heating is carried out with the aid of a tube bundle introduced into the drying chamber, in which moisture released from the boards to be dried condenses in the form of air saturated with moisture. The condensation heat released as latent heat indirectly heats the boards in the dryer. During indirect heating, the goods to be dried, in particular the boards, are ventilated in at least one zone of the dryer transversely to the direction of transportation. The transverse ventilation supports the release of moisture from the s.

Here, the at least first heat exchanger is formed by a first tube bundle, in which moisture condenses from the warm air that has absorbed moisture from the boards as it flows through. The condensed liquid, essentially water, then runs out of the area of the dryer through the tube bundle and can be reused by feeding it back into the process for manufacturing the boards, for example into a mixer or for the preparation of chemicals required for the manufacturing process of the boards.

For this reason alone, it is generally not necessary to actively heat the boards within the first zone or in an area upstream of the first zone by means of a further heater in addition to the indirect first heater formed by the heat exchanger. The boards give off hydration heat, as is the case with gypsum or cement boards, for example, after water has been added to the gypsum or cement in a mixer and this hydration heat is still given off after boards have already been formed from the water-containing pasty gypsum or cement mass; the hydration heat can therefore be utilized as residual heat in the same way as the latent heat released during condensation of the water contained in the warm air in the first zone, which also represents residual heat.

It is therefore usually sufficient to optimize the drying process if active heating of the boards is provided in a second zone following the first zone. The second zone extends longitudinally after the first zone and also comprises a single section or a second plurality of sections. A second heater is provided in this second zone, which is formed, for example, by a gas burner or a plurality of gas burners.

In addition to further heating the boards, the main function of the second zone is to deflect the air flow of warm air from the first zone after the air in the first zone has absorbed moisture from the boards. The air, which is preferably saturated with moisture, is deflected into a heat exchanger in the second zone so that it is now returned in the heat exchanger against the direction of flow of the boards in the first zone above the boards. This causes the warm air to cool down; a considerable proportion of the moisture it contains condenses in the heat exchanger. The heat released during this phase transition can be used again for heating within the first zone, thereby promoting the drying of the boards. The water produced during condensation is drained off.

Finally, a third zone is preferably provided following the second zone in the board conveying direction, in which the drying process of the boards continues. In this third zone, which adjoins the second zone and comprises a single section or a plurality of sections, warm air flows between the shelves of the dryer against the conveying direction of the boards and is heated by a third heater; this warm air thus flows into the second zone and, after absorbing moisture from the boards, is led out of the dryer in the conveying direction by at least one second heat exchanger which, like the first heat exchanger, extends above the shelves of the dryer.

The at least second heat exchanger is formed by a second tube bundle in which moisture condenses from the warm air that has absorbed moisture from the boards as it flows through the third zone, in this case, the condensed liquid is also discharged. The latent heat released during condensation supports the further drying of the boards in the third zone.

The dryer according to the invention can be used as a low-temperature dryer at temperatures below 100° C., but can also be used at higher temperatures, for example below 150° C.

In contrast to the known high-temperature dryers. the low-temperature dryer according to the invention does not require the separate use of cooling zones.

In conventional drying using a high-temperature dryer, the high temperatures lead to dewatering of some of the gypsum dihydrate that has just been formed by reaction during setting on the setting line of the system. Calcium sulphate hemihydrate is formed again. This is undesirable structural damage, which is also avoided with the low-temperature dryer according to the invention.

Instead, a gentle setting of the gypsum or cement in the board to be produced is achieved. A modified starch that is suitable for low temperatures and produces an adhesive effect is used here.

The heat exchangers are preferably formed by tube bundles, which have to provide the heat required. Based on the heat requirement of the dryer, the heat transfer from the tube bundles to the plasterboard in the dryer is determined.

In preferred embodiments of the invention, both tube bundles comprising tubes with a smooth surface and tube bundles comprising tubes with a ribbed surface are used. These fins are, for example, disk fins; however, other means for enlarging the surfaces of the tube bundles can also be implemented.

The heat exchangers used according to the invention are thus air-to-air heat exchangers.

Preferably, fans are present in all three zones, but at least in the first and third zones, which generate a pressure gradient and thus an air flow in the transverse direction to the main flow direction, the longitudinal flow, determined by the conveying of the boards, so that a vortex or spiral-shaped air flow is formed by the superposition of the two flow directions.

The ratio of the transverse flow to the longitudinal flow. the vortex pitch angle, influences the dwell time of the air in the dryer. This angle or, alternatively or additionally, the moisture measured in the dryer are suitable as reference variables in a control circuit whose task variable is the moisture to be maintained at the end of the dryer in the sheets or continuous material to be dried.

The air in the first zone heats up to 60 to 90° C. at the air-to-air heat exchanger of the first zone. In the second zone, the drying air is heated to around 90 to 95° C. using several gas burners. Most of the water evaporates from the boards in this zone. The moist air then flows against the direction of travel of the boards through the inside of the heat exchanger in the first zone. The exhaust air in the finned tubes cools down and approx. 48% of the water it contains condenses. The heat released in the process is used again to heat the fresh drying air.

The recirculated condensation heat, for example, accounts for more than a third of the total amount of heat in the first zone.

The at least one fan in the second zone is used to generate a continuous negative pressure and thereby divert the air flow into the first heat exchanger.

At least one fan serving as a recirculation fan is therefore provided for each zone. This generates a secondary flow transverse to the board conveying direction. The secondary flow supports the heat transfer at the tube bundle and also ensures an intensive flow around the boards to be dried and better heat transfer there. The drying temperature of the hot air is 60° C. It is assumed that the air has cooled down to 45° C., for example, after one flow pass. The temperature of the boards is then 40° C., for example.

Knowing the pressure loss in the heat exchanger, in particular the tube bundle, allows the design of fan motors for generating and distributing the drying air flow to be determined.

A pressure gradient is generated in the dryer to remove the moisture; preferably, this pressure gradient is achieved in the first zone by a pressure-side fan arranged in the second zone, in particular at the level of the heat exchanger of the first zone, forcing the moist air into the heat exchanger. Alternatively or additionally, the dehumidified air in the heat exchanger is drawn out by means of a fan arranged on the inlet side of the dryer and thus the first zone.

In addition or as an alternative to the fan on the inlet side, a chimney is provided at the inlet area, which also generates a vacuum and directs the dehumidified air out of the dryer.

In order to redirect the humid air from the second zone into the first zone, guide or deflection means, in particular guide, throttle, baffle or deflection plates, are arranged there, especially if at least one fan is present there, in particular in its vicinity. The same applies to the deflection of the air from the second zone into the third zone. At least one fan is also used for this in the second zone, which forces the air drawn in from the third zone against the transport direction of the boards into the heat exchanger in the transport direction of the boards. Alternatively or additionally, on the outlet side of the dryer, an additional fan sucks in the air flowing out of the dryer.

The invention also relates to a system comprising a dryer as described above. The system is characterized in that it comprises a device for generating energy, in particular a photovoltaic system or a wind power system or a heat pump, or another device for generating regenerative energy, the energy of which can be used for driving the boards to be dried through the dryer and/or for operating the fans and/or for heating the boards by heating means.

The invention also relates to a method for drying boards in a dryer. This method is characterized in that the boards, while they are conveyed through the dryer in the longitudinal direction at a temperature below 130° C. using a heating means, are heated to a temperature below 130° C. in a first zone in the longitudinal direction and in the conveying direction of the boards with warm air generated by a first heater flowing between the shelves in a section or in a first plurality of sections, and in that the air, after absorbing moisture from the boards, is led out of the dryer through at least one first heat exchanger in the opposite direction to the conveying direction.

The invention is explained in more detail below with reference to embodiment examples. It shows:

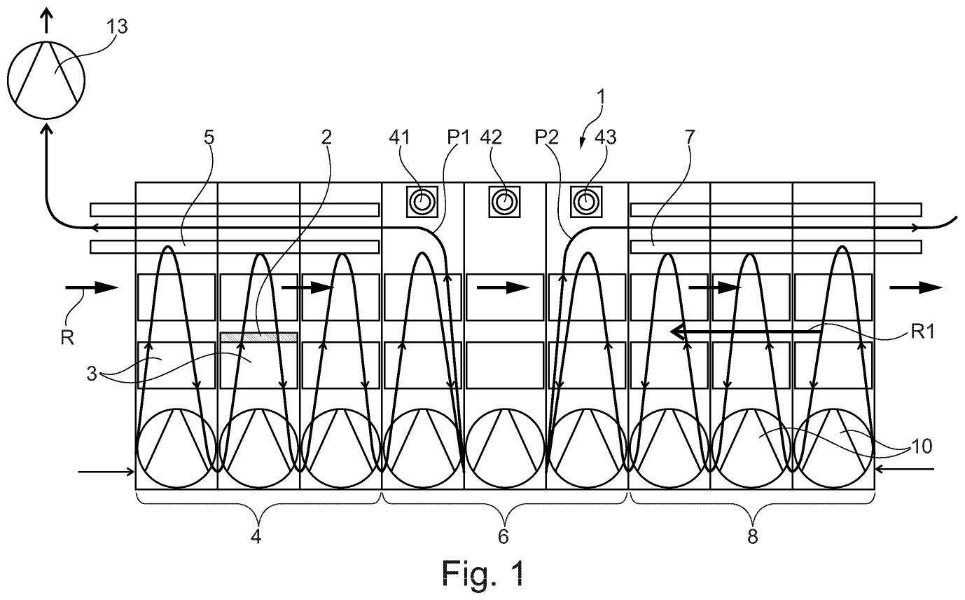

FIG. 1 a schematic view of a dryer with three zones for drying boards and

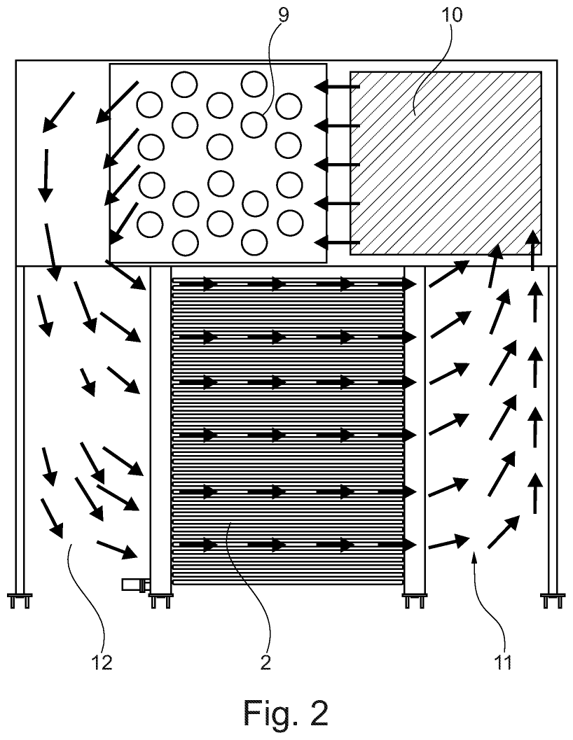

FIG. 2 a sectional view through the dryer in the first or third zone.

A dryer 1 (FIGS. 1, 2) for drying boards 2 is divided in a known manner into a plurality of fields or sections 3, the length of which corresponds approximately to the length of the boards 2 to be processed. For example, a dryer for drying gypsum boards has sections 3 with a length of 2400 mm corresponding to the length of the gypsum boards 2.

A first group of sections 3 forms a first zone 4, in which the boards 2 are initially exposed to warm air at a temperature of between 60 and 75° C. in the conveying direction R of the dryer 1, which is provided by a heat exchanger 5 located above zone 4 and formed, for example, by a tube bundle. The warm air passes over the boards 2, which are arranged in, for example, forty levels one above the other, in the conveying direction R.

In a second zone 6, which also covers a plurality of boards 2, this air flow is deflected against the conveying direction R into a heat exchanger 5 in the direction of an arrow P1, in which the warm air, which has absorbed moisture from the boards 2 in zone 4, loses some of this moisture again through condensation; the latent heat released in zone 4 is returned from the heat exchanger 5 back to the shelves to the boards 2, while the liquid condensed in the heat exchanger 5 is discharged from the dryer 1.

Zone 6 is also used to heat the boards 2 to a temperature between 90 and 95° C. For this purpose, heaters 61, 62, 63, for example in the form of gas burners, are provided in zone 6.

Zone 6 is followed by zone 8, which is equipped with a heat exchanger 7 like zone 4; in zone 8, the temperature of the warm air above the boards 2 drops to a temperature of between 60 and 75° C., whereby the air again absorbs moisture from the boards 2, flowing against the conveying direction R of the boards 2 in the direction of an arrow R1 and, after it is saturated with moisture, releases it again in the area of zone 6 into the heat exchanger 7 by condensation, whereby the air flows in the direction of an arrow P2 into the heat exchanger 7, so that it flows in this in the conveying direction of the boards 2.

Both heat exchangers 5, 7 are preferably designed as tube bundles 9 (FIG. 2). Fans 10, preferably extending over the entire length of the dryer 1, are designed as recirculation fans to generate a vortex or spiral-shaped air flow; the fans 10 direct the air, which has absorbed moisture from the boards 2, through the tube bundles 9 of the heat exchangers 5, 7 via a chamber 11 arranged at the side of the shelves for transporting the boards 2 and direct the air back to the boards 2 through a chamber 12

Fans such as the fan 13 shown in FIG. 1 are also preferably arranged at the front ends of the dryer 1 in order to guide air out of the dryer 1 on the inlet and outlet sides and to extract it from the heat exchangers 5, 6.

The fans 10 are preferably arranged in a ceiling box above the bays 3, in which the boards 2 are transported on the shelves by means of roller conveyors. The chambers 11, 12 are provided at the sides of the bays 3, in which the warm air flows in a vortex while it is simultaneously guided through the dryer 1.

1. A dryer for drying boards to be conveyed through the dryer in a plurality of sections extending one behind the other in the longitudinal direction and each having a plurality of levels, using a heating medium at a temperature below 130° C., wherein the boards are dried during the drying process in a first zone in the longitudinal direction and in the conveying direction of the boards with warm air flowing between the levels, the boards can be heated to a temperature below 130° C. in a first zone in the longitudinal direction and in the conveying direction of the boardswith warm air generated by a first heater in a section or in a first plurality of sections, and in that the air can be led out of the dryer through at least one first heat exchanger counter to the conveying direction after the moisture has been absorbed from the boards.

2. The dryer according to claim 1, wherein the at least first heat exchanger is formed by a first tube bundle in which moisture from the warm air, which has absorbed moisture from the boards as it flows through, can be condensed.

3. The dryer according to claim 1, wherein the boards can be heated by a second heater in a second zone which extends longitudinally after the first zone and also comprises a single section or a second plurality of sections.

4. The dryer according to claim 3, wherein the warm dryer air, after it has absorbed moisture from the boards in the first zone, can be deflected in the second zone and can be led out of the dryer through the first heat exchanger.

5. The dryer according to claim 1, wherein during the drying process in a third zone adjoining the second zone, zone adjoining the second zone and comprising a single section or a plurality of sections can be heated in the longitudinal direction by a third heater with warm air flowing between the shelves against the conveying direction of the boards in one section or a plurality of sections, and in that the warm air can be led out of the dryer in the transport direction through at least one second heat exchanger after the absorption of moisture from the boards.

6. The dryer according to claim 5, wherein the at least second heat exchanger is formed by a second tube bundle, in which moisture from the warm air, which has absorbed moisture from the boards when flowing through the third zone, can be condensed.

7. The dryer according to claim 1, wherein the dryer can be used as a low-temperature dryer at temperatures below 100° C.

8. An installation comprising a dryer according to claim 1, wherein it comprises a device for generating energy, the energy of which can be used to drive the boards to be dried through the dryer and/or to operate the fans and/or to heat the boards by heating means.

9. A method for drying boards in a dryer, wherein the boards, while they are conveyed through the dryer in the longitudinal direction using a heating means at a temperature below 130° C., are heated in a first zone in the longitudinal direction and in the conveying direction of the boards with warm air flowing between the levels, in a first zone in the longitudinal direction and in the conveying direction of the boards to a temperature below 130° C. with warm air generated by a first heater and that the air, after absorbing moisture from the boards, is led out of the dryer through at least one first heat exchanger against the conveying direction.

10. The method according to claim 9, wherein the boards are heated in a second zone extending in the longitudinal direction after the first zone by a second heater.

11. The method according to claim 9, wherein, during the drying process, the boards are heated in a third zone adjoining the second zone in the longitudinal direction with warm air flowing between the levels against the conveying direction of the boards in a section or a plurality of sections by a third heater, and in that the warm air is led out of the dryer in the transport direction through at least one second heat exchanger after the absorption of moisture from the boards.

12. The method according to claim 9, wherein the warm air is passed through the dryer in a vortex shape by fans.
